(19) United States
(12) Patent Application Publication
(10) Pub. No.: US 2014/0003752 A1
(43) Pub. Date: Jan. 2, 2014

(54) STEEL AND COMPONENT

(71) Applicant: Thore Lund, Goteborg (SE)

(72) Inventor: Thore Lund, Goteborg (SE)

(21) Appl. No.: 13/994,024

(22) PCT Filed: Dec. 6, 2011
(86) PCT No.: PCT/SE11/00220

§ 371 Date: Sep. 17, 2013

(30) Foreign Application Priority Data
Dec. 13, 2010 (SE) 1001183-1

(51) Int. Cl. C22C 38/48; C22C 38/44; F16C 33/30; C22C 38/06; C22C 38/04; C22C 38/02; C22C 38/46; C22C 38/42

(52) U.S. Cl. CPC C22C 38/48; C22C 38/46; C22C 38/44; C22C 38/42; C22C 38/06; C22C 38/04; C22C 38/02; F16C 33/30
USPC 384/456; 420/91; 420/103; 420/108; 420/109; 403/404

(57) ABSTRACT

Steel for a high temperature joining process suitable, in particular for components intended for applications with high demands on fatigue and toughness properties, such as bearing components, comprising the following composition in weight-%: 0.5-0.8 C, 0- 0.15 Si, 0-1.0 Mn, 0.01-2.0 Cr, 0.01-1.0 Mo, 0.01-2.0 Ni, 0.01-1.0 of V or 0.01-1.0 of Nb, or 0.01-1.0 of both V and Nb, 0-0.002 S, 0-0.010 P, 0-0.15 Cu, 0.010-1.0 Al, the remainder being Fe and normally occurring impurities.

### TECHNICAL FIELD

The present invention concerns steel that is suitable for a high temperature joining process and a bearing component comprising such steel.

### BACKGROUND OF THE INVENTION

Many metal components are subjected to a high temperature joining process, such as flash butt welding, during their manufacture.

Flash-butt welding is a resistance welding technique for joining segments of metal rail, rod, chain or pipe in which the segments are aligned end to end and electronically charged, producing an electric arc that melts and welds the ends of the segments, yielding an exceptionally strong and smooth joint.

A flash butt welding circuit usually consists of a low-voltage, high-current energy source (usually a welding transformer) and two clamping electrodes. The two segments that are to be welded are clamped in the electrodes and brought together until they meet, making light contact. Energizing the transformer causes a high-density current to flow through the areas that are in contact with each other. Flashing starts, and the segments are forged together with sufficient force and speed to maintain a flashing action. After a heat gradient has been established on the two edges to be welded, an upset force is suddenly applied to complete the weld. This upset force extrudes slag, oxides and molten metal from the weld zone leaving a welding accretion in the colder zone of the heated metal. The joint is then allowed to cool slightly before the clamps are opened to release the welded article. The welding accretion may be left in place or removed by shearing while the welded article is still hot or by grinding, depending on the requirements.

During the flash butt welding process, when two surfaces are forged together, a material flow perpendicular to the plane of the two surfaces is created. This material flow forms a grain structure or fibre flow oriented perpendicular to the plane of the two surfaces.

Inclusions present within the material become incorporated in this material flow.

When a component, such as a steel bearing ring, is being flash butt welded, the resulting material flow carrying inclusions is unfavourable with respect to fatigue crack initiation and propagation in the finished welded bearing ring compared to a bearing that does not comprise a flash butt weld joint. On cooling, inclusions in the steel may namely precipitate at the steel's grain boundaries which will significantly weaken the weld zone. Furthermore, grain growth is rapid at the high temperatures involved when flash butt welding and a large austenitic grain size will significantly reduce the strength of the bearing ring compared to a bearing ring that does not comprise a flash butt weld joint. Additionally, flash butt welding is carried out under heavily oxidising conditions which may adversely affect the quality of the steel in the vicinity of the flash butt weld.

Since the severity of all of these factors that can adversely affect the physical properties of steel in the vicinity of a flash butt weld depends on the composition of the steel, not all steel compositions are suitable for use in high temperature joining processes, such as flash butt welding. Varying the amount of alloying elements in the steel will influence physical properties such as the hardness, ductility and tensile strength of the resulting steel. Such variations must however be carefully controlled since a variation that results in an improvement of one physical property can have a detrimental effect on another physical property. For example, steel with over-eutectoid carbon content can generate weld zone problems as too much carbon is dissolved into the austenite generated during welding.

### SUMMARY OF THE INVENTION

An object of the invention is to provide steel suitable for a high temperature joining process, i.e. any process in which the steel is heated to, close to or above its solidus temperature.

This object is achieved by steel comprising the following composition in weight-%:

| | |
|---|---|
| C | 0.5-0.8 |
| Si | 0-0.15 |
| Mn | 0-1.0 |
| Cr | 0.01-2.0 |
| Mo | 0.01-1.0 |
| Ni | 0.01-2.0 |
| V and/or Nb | 0.01-1.0 of V or 0.01-1.0 of Nb, or 0.01-1.0 of |
| | both elements |
| S | 0-0.002 |
| P | 0-0.010 |
| Cu | 0-0.15 |
| Al | 0.010-1.0 |

the remainder being Fe and normally occurring impurities.

It has been found by ensuring that the steel does not contain more than 0.7 weight-% C grain boundary carbides will be avoided or substantially reduced and a desired small grain size (having a primary austenite grain size of 50-100 m for example) will be obtained when the steel is subjected to a high temperature joining process. The rate of grain growth will be reduced due to the addition of one or both of the elements vanadium and/or niobium.

By minimizing the silicon content, and reducing the manganese and chromium content of the steel (which are alloying elements that are easily oxidised) to the levels indicated above, the steel will be more stable and will not be as easily oxidised during a high temperature joining process, such as flash butt welding. The sulphur content of the steel is reduced to an absolute minimum whereby the content of non-desirable non-metallic inclusions in steel that has been subjected to a high temperature joining process will be minimized A high level of through-thickness ductility may be obtained by means of a special ladle treatment during steelmaking which ensures very low sulphur content and a controlled shape of non-metallic inclusions.

The phosphorus content of the steel is also reduced to an absolute minimum in order to hinder residual or tramp elements in the steel migrating to austenite grain boundaries when the steel is subjected to a high temperature joining process, which will significantly weaken the weld zone. The addition of molybdenum, nickel and optionally vanadium provides steel with a hardenability sufficient to enable through-hardening of large components (i.e. a DI of 400 mm or more).

The adverse effects of the unfavourable material flow that a high temperature joining process, such as flash butt welding, creates may therefore be limited by manufacturing a component that is to be subjected to high temperature joining process out of such steel. Using such steel namely provides a joined/welded component having a superior joint/weld since the joined/welded component does not contain areas of structural weakness as might otherwise occur. Such a joined/welded component therefore has a high degree of structural integrity compared to joined/welded component that does not comprise such steel. Such steel is therefore suitable for high temperature joining processes and in particular for the manufacture of components intended for an application with high demands on fatigue and toughness properties, which components are to be subjected to high temperature joining process during or after their manufacture.

The present invention also concerns a component intended for an application with high demands on fatigue and toughness properties that comprises steel having such a composition. The component may for example be a bearing component, such as a bearing ring or a bearing ring segment, two or more of which may be joined/welded together to form a bearing ring.

According to an embodiment of the invention the component comprises at least one high temperature joining process joint, such as at least one flash butt weld joint.

According to an embodiment of the invention the component may constitute at least part of one of the following: a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, or a component for an application in which it is subjected to alternating Hertzian stresses, such as rolling contact or combined rolling and sliding and/or an application that requires high wear resistance and/or increased fatigue and tensile strength.

The present invention also concerns the use of steel having the above-mentioned composition for a high temperature joining process, such as flash butt welding.

### BRIEF DESCRIPTION OF THE DRAWINGS

The present invention will hereinafter be further explained by means of non-limiting examples with reference to the appended schematic figures in which;

FIG. 1 schematically shows a bearing component according to an embodiment of the invention,

FIG. 2 shows a bearing ring according to an embodiment of the invention prior to flash butt welding,

FIG. 3 shows two ends of a bearing component according to an embodiment of the invention being flash butt welded,

FIG. 4 shows the material flow at the surfaces of a bearing component during flash butt welding, and

FIG. 5 shows how phosphorus content affects the toughness of steel.

It should be noted that the drawing has not been drawn to scale and that the dimensions of certain features have been exaggerated for the sake of clarity.

### DETAILED DESCRIPTION OF EMBODIMENTS

FIG. 1 schematically shows an example of a bearing component 10, namely a rolling element bearing that may range in size from 10 mm in diameter to a few metres in diameter and have a load-carrying capacity from a few tens of grams to many thousands of tonnes. The bearing component according to the present invention may namely be of any size and have any load-carrying capacity. The bearing component 10 has an inner ring 12, an outer ring 14 and a set of rolling elements 16. The inner ring 12, the outer ring 14 and/or the rolling elements 16 of the rolling element bearing 10, and preferably all of the rolling contact parts of the rolling element bearing 10 are manufactured from steel that comprises in weight-%: 0.5-0.8 C, 0-0.15 Si, 0-1.0 Mn, 0.01-2.0 Cr, 0.01-1.0 Mo, 0.01-2.0 Ni, 0.01-V or 0.01-1.0 of Nb, or 0.01-1.0 of both V and Nb, 0-0.002 S, 0-0.010 P, 0-0.15 Cu, 0.010-1.0 Al, the remainder being Fe and normally occurring impurities.

For example, the steel may comprise 0.7% C, 0.1 Si, 0.7 Mn, 1.3 Cr, 0.5 Mo, 1.0 Ni, 0.15 V, 0.001 S, 0.008 P, 0.10 Cu, 0.035 Al, the remainder being Fe and normally occurring impurities. Such a steel will have a DI of over 400 mm

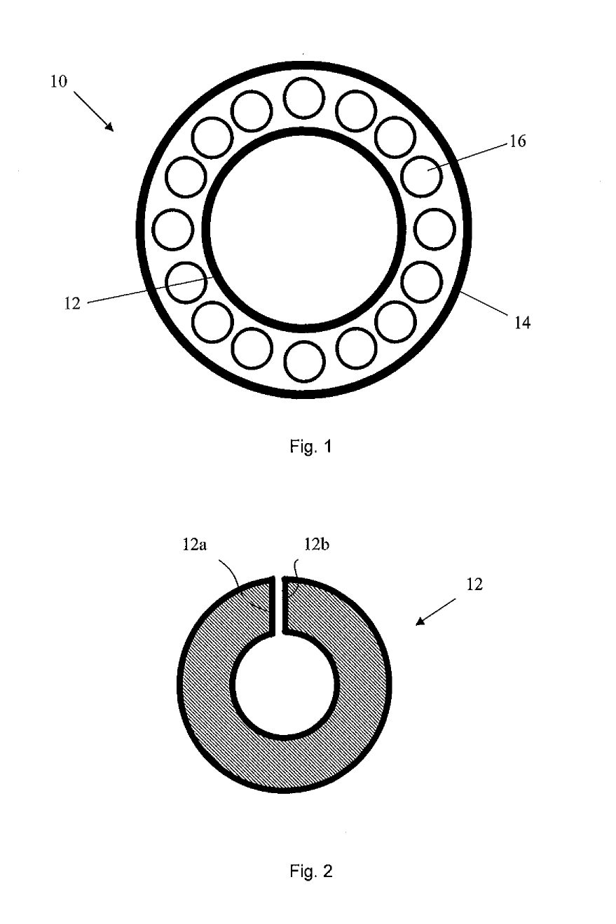

FIG. 2 shows an open bearing ring 12, such as the inner ring of a roller bearing, prior to being flash butt welded. The bearing ring 12 is manufactured from steel having the composition mentioned above. The open bearing ring 12 in the illustrated embodiment comprises two ends 12a, 12b that are to be welded together by flash butt welding to form a flash butt weld joint. It should be noted that such a bearing ring 12 may comprise two or more bearing ring segments whose ends are welded together by flash butt welding to form a bearing ring comprising a plurality of flash butt weld joints.

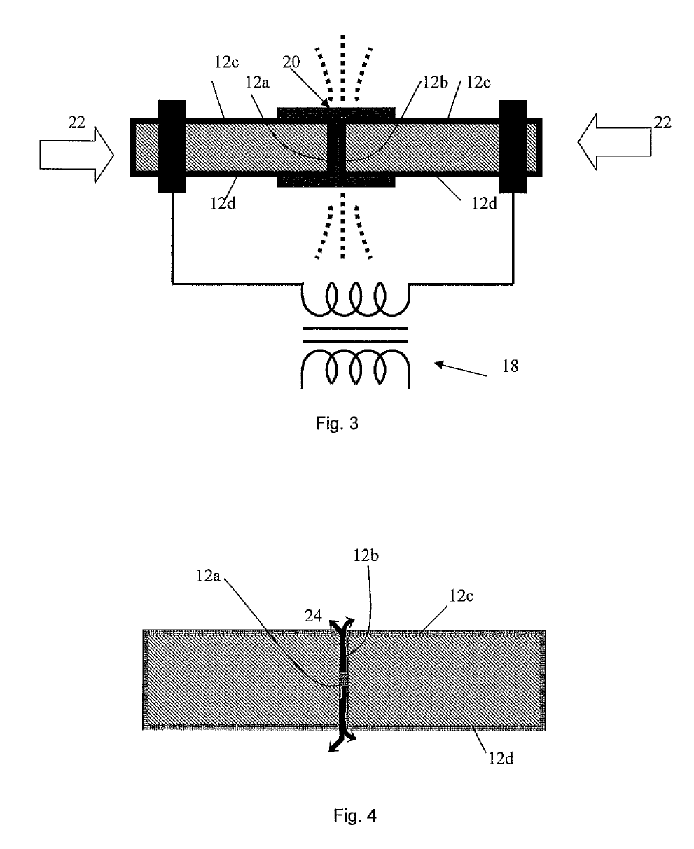

FIG. 3 shows the ends 12a, 12b of an open bearing ring 12 being flash butt welded together. The ends 12a, 12b of the open bearing ring 12 are clamped and brought together at a controlled rate and current from a transformer 18 is applied. An arc is created between the two ends 12a, 12b. At the beginning of the flash butt welding process, the arc gap 20 is large enough to even out and clean the two surfaces 12a, 12b. Reducing and then closing and opening the gap 20 creates heat in the two surfaces 12a, 12b. When the temperature at the two surfaces 12a, 12b has reached the forging temperature, pressure is applied in the directions of arrows 19 in FIG. 3 (or a moveable end is forged against a stationary end). A flash is created between the two surfaces 12a, 12b, which causes material in the welding area to flow radially outwards from the surfaces 12a, 12b towards the inside and outside surfaces 12c, 12d of the bearing ring 12, as indicated by the arrows 24 in FIG. 4.

After cooling in air on in a water-, oil- or polymer-based quench for example, any welding accretion which accumulates on the inner and outer surfaces 12d and 12c of the welded bearing ring 12 may be removed.

It should be noted that the ends 12a, 12b of the steel bars 12 shown in the illustrated embodiments comprise ends that form an angle of 90° to a side surface 12c, 12d of the steel bars 12. A steel bar 12 may however comprise an end 12a, 12b that forms an angle greater or less than 90° to a side surface 12c, 12d of a steel bar, a steel bar 12 may namely comprise diagonally sloping ends.

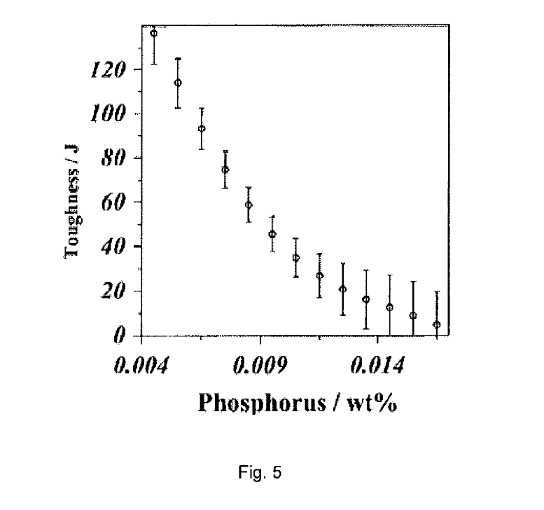

FIG. 5 is a graph of phosphorus content in weight-% against the toughness of steel. It can be seen that the higher the phosphorus content, the lower the toughness of the steel. It has been found that the optimum phosphorus content in steel for a high temperature joining process is 0-0.010 weight-%.

Further modifications of the invention within the scope of the claims will be apparent to a skilled person.

1. Steel for a high temperature joining process, comprising the following composition in weight-%:

| | |
|---|---|
| C | 0.5-0.8 |
| Si | 0-0.15 |
| Mn | 0-1.0 |
| Cr | 0.01-2.0 |
| Mo | 0.01--1.0 |
| Ni | 0.01--2.0 |
| V and/or Nb | 0.01-1.0 of V or 0.01-1.0 of Nb, or 0.01-1.0 |
| | of both elements |
| S | 0-0.002 |
| P | 0-0.010 |
| Cu | 0-0.15 |
| Al | 0.010-1.0 |

balance Fe and normally occurring impurities.

2. A component intended for an application with high demands on fatigue and toughness properties, comprising:
steel having the following composition in weight-%:

| | |
|---|---|
| C | 0.5-0.8 |
| Si | 0-0.15 |
| Mn | 0-1.0 |
| Cr | 0.01-2.0 |
| Mo | 0.01--1.0 |
| Ni | 0.01--2.0 |
| V and/or Nb | 0.01-1.0 of V or 0.01-1.0 of Nb, or 0.01-1.0 |
| | of both elements |
| S | 0-0.002 |
| P | 0-0.010 |
| Cu | 0-0.15 |
| Al | 0.010-1.0 |

balance Fe and normally occurring impurities.

3. The component according to claim 2, wherein the component further comprises a bearing component.

4. The component according to claim 3, wherein the component further comprises at least one high temperature joining process joint.

5. The component according to claim 4, wherein the at least one high temperature joining process joint is at least one flash butt weld joint.

6. The component according to claim 5, wherein the component further comprises a bearing ring or a bearing ring segment.

7. The component according to claim 6, wherein the component further comprises constitutes at least part of one of the following: a ball bearing, a roller bearing, a needle bearing, a tapered roller bearing, a spherical roller bearing, a toroidal roller bearing, a ball thrust bearing, a roller thrust bearing, a tapered roller thrust bearing, a wheel bearing, a hub bearing unit, a slewing bearing, a ball screw, or a component for an application subjected to alternating Hertzian stresses, such as rolling contact or combined rolling and sliding and/or an application that requires high wear resistance and/or increased fatigue and tensile strength.

8. (canceled)

9. The steel for a high temperature joining process according to claim 1, wherein the high temperature joining process is flash butt welding.
